(19) United States
(12) Patent Application Publication
(10) Pub. No.: US 2020/0219166 A1
(43) Pub. Date: Jul. 9, 2020

(54) APPARATUS AND METHOD FOR PROVIDING FASHION COORDINATION KNOWLEDGE BASED ON NEURAL NETWORK HAVING EXPLICIT MEMORY

(71) Applicant: ELECTRONICS AND TELECOMMUNICATIONS RESEARCH INSTITUTE, Daejeon (KR)

(72) Inventors: Hyun Woo KIM, Daejeon (KR); Hwa Jeon SONG, Daejeon (KR); Eui Sok CHUNG, Daejeon (KR); Ho Young JUNG, Daejeon (KR); Jeon Gue PARK, Daejeon (KR); Yun Keun LEE, Daejeon (KR)

(21) Appl. No.: 16/711,934

(22) Filed: Dec. 12, 2019

(30) Foreign Application Priority Data
Jan. 8, 2019 (KR) 10-2019-0002415

(51) Int. Cl. G06Q 30/06; G06N 5/02; G06N 3/04; G06F 17/18

(52) U.S. Cl. CPC G06Q 30/0631; G06F 17/18; G06N 3/0472; G06N 5/02

(57) ABSTRACT

A method and apparatus for estimating a user's requirement through a neural network which are capable of reading and writing a working memory and for providing fashion coordination knowledge appropriate for the requirement through the neural network using a long-term memory, by using the neural network using an explicit memory, in order to accurately provide the fashion coordination knowledge. The apparatus includes a language embedding unit for embedding a user's question and a previously created answer to acquire a digitized embedding vector; a fashion coordination knowledge creation unit for creating fashion coordination through the neural network having the explicit memory by using the embedding vector as an input; and a dialog creation unit for creating dialog content for configuring the fashion coordination through the neural network having the explicit memory by using the fashion coordination knowledge and the embedding vector an input.

### CROSS-REFERENCE TO RELATED APPLICATION

This application claims priority to and the benefit of Korean Patent Application No. 10-2019-0002415, filed on Jan. 8, 2019, the disclosure of which is incorporated herein by reference in its entirety.

### BACKGROUND

### 1. Field of the Invention

The present invention relates to a method and apparatus for providing knowledge through a neural network, and more particularly, to a technique for providing fashion coordination knowledge through a neural network having an explicit memory.

### 2. Description of Related Art

Deep learning using a neural network is a machine learning algorithm that attempts to achieve a high level of abstraction from data by utilizing input/output layers similar to those of brain neurons and has shown the best results in many fields. Representatively, a deep neural network, a convolutional neural network, a recurrent neural network and the like are provided. Recently, like a Von Neumann architecture-based computing model, research is being conducted to improve performance by a neural network explicitly separating logical flow control and an external memory and then performing processing. A neural Turing machine, an end-to-end memory network, differential neural computing (DNC) and the like have been proposed as a neural network method having an explicit memory.

Fashion coordination knowledge denotes knowledge for creating a combination of fashion items with consideration of user requirements for Time, Place, and Occasion (TPO) associated with fashion. Generally, the user requirements are acquired through dialogue, and the fashion coordination knowledge is acquired by performing a supervised learning or a reinforcement learning through a user's reaction. In order to create accurate fashion coordinate knowledge, there is a need to sufficiently utilize previous context information and fashion histories of the user requirements, but conventional neural network methods that do not use explicit memory have limitations in using such information. Moreover, the conventional methods cannot create fashion coordination knowledge appropriate to rare TPO.

### SUMMARY OF THE INVENTION

The present inventors propose a method and apparatus for estimating a user's requirement through a neural network which are capable of reading and writing a working memory and for providing fashion coordination knowledge appropriate for the requirement through the neural network using a long-term memory by using the neural network having an explicit memory in order to accurately provide the fashion coordination knowledge.

In order to achieve the objective, an apparatus for providing fashion coordination knowledge based on a neural network having an explicit memory according to an aspect of the present invention includes: a language embedding unit configured to embed a user's question and a previously created answer to acquire a digitized embedding vector; a fashion coordination knowledge creation unit configured to create fashion coordination knowledge through the neural network having the explicit memory by using the embedding vector acquired by the language embedding unit as an input; and a dialog creation unit configured to create dialog content for configuring the fashion coordination through the neural network having the explicit memory by using the fashion coordination knowledge acquired from the fashion coordination knowledge creation unit and the embedding vector acquired from the language embedding unit as an input.

Also, a method of providing fashion coordination knowledge based on a neural network having an explicit memory according to another aspect of the present invention includes: embedding a user's question and a previously created answer to acquire a digitized embedding vector; creating fashion coordination knowledge through the neural network having the explicit memory by using the embedding vector as an input; and creating dialog content for configuring the fashion coordination through the neural network having the explicit memory by using the created fashion coordination knowledge and the embedding vector as an input.

The above-described configurations and effects of the present invention will become more apparent from the following embodiments which will be described with reference to the drawings.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram showing an embodiment of an apparatus for providing fashion coordination knowledge using a neural network having an explicit memory according to the present invention;

FIG. 2 shows an example input of a language embedding unit;

FIG. 3 shows a result of embedding the input of FIG. 2;

FIG. 4 shows an example type of a fashion item;

FIG. 5 is a detailed diagram of a fashion coordination knowledge creation unit 20;

FIG. 6 shows an example feature of a fashion item;

FIG. 7 shows an example of a specific fashion item; and

FIG. 8 is a learning configuration diagram of a neural network having an explicit memory used for the fashion coordination knowledge provision apparatus of FIG. 1

### DETAILED DESCRIPTION OF EXEMPLARY EMBODIMENTS

The advantages and features of the present invention and methods of accomplishing the same will be apparent by referring to embodiments described below in detail in connection with the accompanying drawings. The present invention may, however, be embodied in different forms and should not be construed as limited to the embodiments set forth herein. Rather, these embodiments are provided so that this invention will be thorough and complete and will fully convey the scope of the present invention to those skilled in the art. Therefore, the scope of the invention is defined only by the appended claims.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. The terms “comprise” and/or “comprising,” when used in this specification, specify the presence of stated elements, steps, operations, and/or components, but do not preclude the presence or addition of one or more other elements, steps, operations, and/or components.

Preferred embodiments of the present invention will be described below in more detail with reference to the accompanying drawings. When assigning a reference number to each component shown in the drawings, it should be noted that the same components are given the same reference numbers even though they are shown in different drawings. Further, in the following description of the present invention, a detailed description of known functions and configurations incorporated herein will be omitted when it is determined that the description may make the subject matter of the present invention unclear.

Hereinafter, embodiments of the present invention will be described in detail with reference to the accompanying drawings.

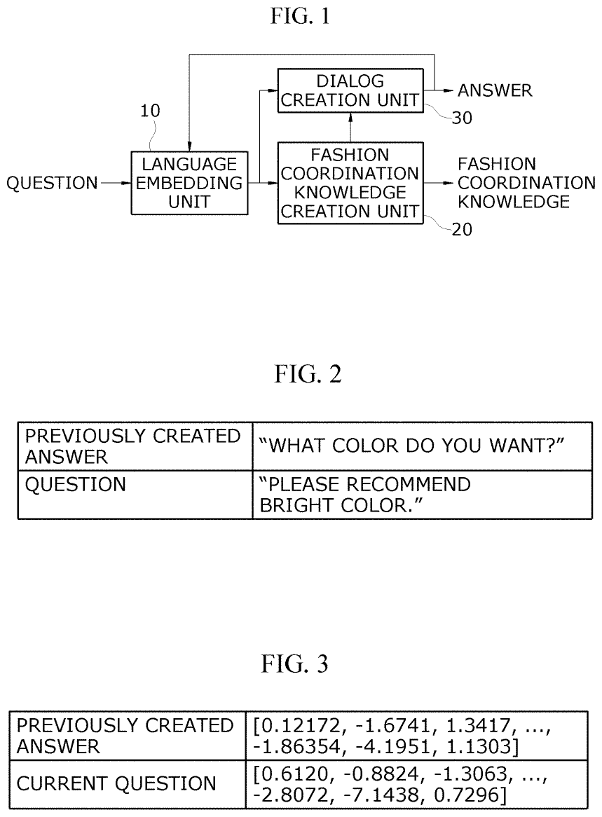

FIG. 1 is a block diagram showing an embodiment of an apparatus for providing fashion coordination knowledge using a neural network having an explicit memory according to the present invention. The present invention will be described below using “unit” and “part,” which indicate element names in terms of apparatuses, but the description of the configuration aspects may cover the description of the method aspects of the present invention.

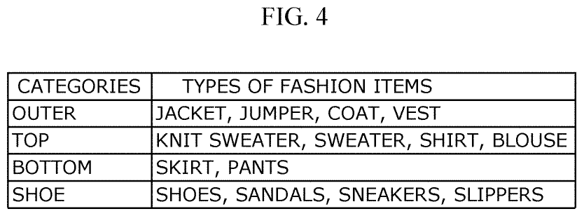

A language embedding unit 10 embeds a question expressed through language and a previously created answer to create a digitized vector of a fixed dimension. Also, words included in the question and the previously created answer are converted into vectors using Word2Vec provided by Google, fastText provided by Facebook, or the like, and an embedding vector is obtained by averaging or summing the word vectors. For example, an input is received as shown in FIG. 2. FIG. 3 shows a result of embedding the input of FIG. 2.

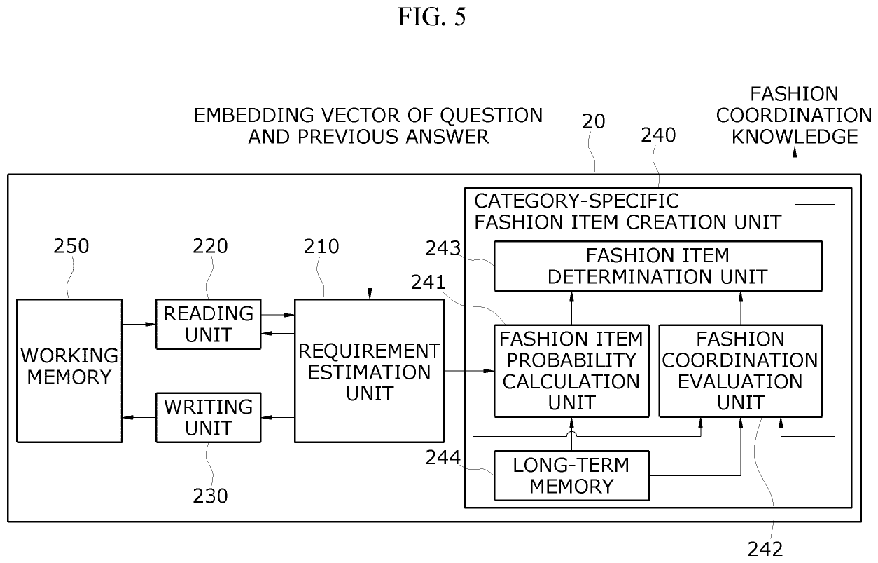

A fashion coordination knowledge creation unit 20 creates fashion coordination knowledge through a neural network having an explicit memory by using the embedding vector acquired by the language embedding unit 10 as an input. Fashion coordination is formed in a combination of fashion items. The type of fashion item is classified according to categories corresponding to wearing positions, and the same categories cannot be combined. For example, the type of fashion item may have a category classified according to the wearing positions as in FIG. 4. The fashion coordination knowledge creation unit 20 will be described below in detail with reference to FIG. 5.

Referring to FIG. 1 again, a dialog creation unit 30 requests additional information for configuring fashion coordination or creates an answer to describe new fashion coordination, by using, as the input to the a neural network, embedding vector acquired by the language embedding unit 10 and the fashion coordination acquired by the fashion coordination knowledge creation unit 20. Here, the neural network used may be, for example, a long short-term memory (LSTM) recurrent neural network-based “sequence-to-sequence” structure known to have good performance in creating a dialog.

In the apparatus for creating fashion coordination knowledge through a neural network having an explicit memory according to the present invention as shown in FIG. 1, elements other than the language embedding unit 10 are differentiable in order to perform end-to-end learning through a back-propagation algorithm.

FIG. 5 shows an embodiment of a configuration of the fashion coordination knowledge creation unit 20 of the apparatus for creating fashion coordination knowledge through a neural network having an explicit memory as shown in FIG. 1. Referring to FIG. 5, the fashion coordination knowledge creation unit 20 includes a requirement estimation unit 210, a reading unit 220, a writing unit 230, and a category-specific fashion item creation unit 240. And the unit 20 utilizes a working memory 250 and a long-term memory 244, unlike the conventional technology.

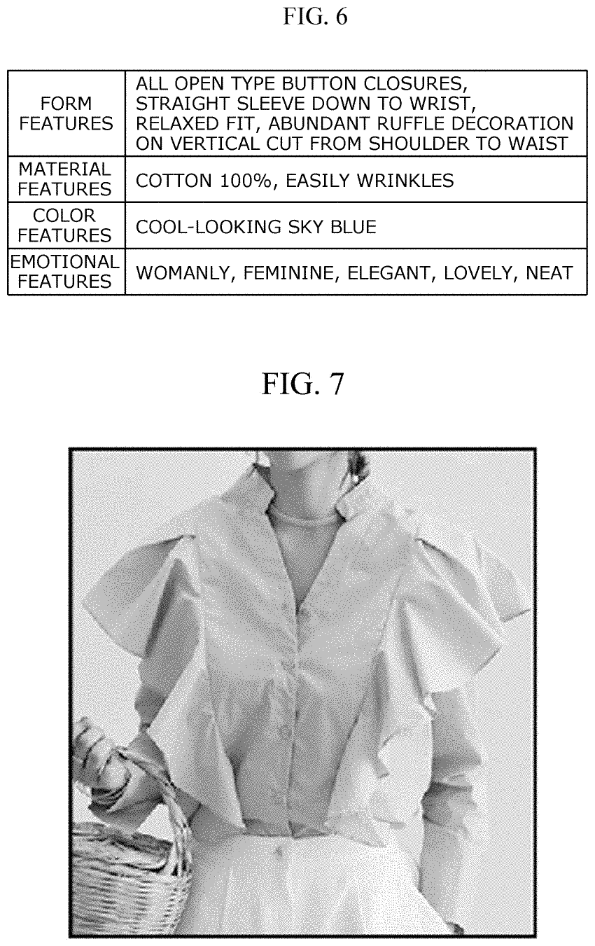

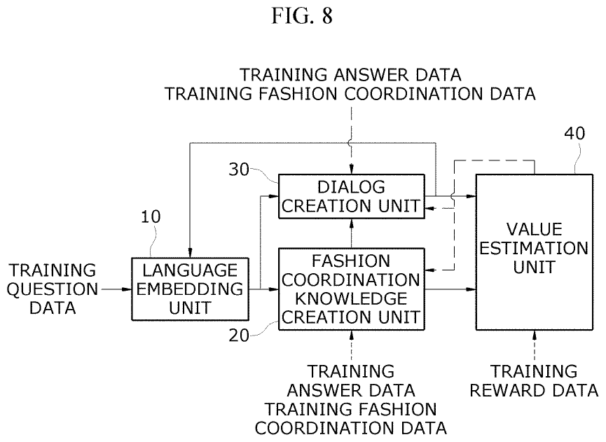

The operation of the fashion coordination knowledge creation unit 20 together with these memories will be described first, for the sake of understanding. The working memory 250 is a storage that memorizes previous questions and answers in order to estimate the user requirements. A memory value may be a deterministic value or a statistic value (e.g., average, variance, etc.). The long-term memory 244 is a storage that memorizes features of fashion items. Features expressed through language of the fashion items are in advance acquired by embedding. For example, as shown in FIG. 6, form features, material features, color features, and emotion features may be used for the features of the fashion items. FIG. 6 describes the features of a specific fashion item example shown in FIG. 7. As described above, the features of the fashion item expressed through language using the language embedding unit 10 shown in FIG. 1 are converted into a feature vector through the embedding. The feature vectors of all the fashion items are stored in the long-term memory 244.

An action of creating new fashion coordination may include a series of actions for creating category-specific fashion items according to the user requirements. For example, the category-specific fashion item creation unit 240 of FIG. 5 creates new fashion coordination by sequentially creating fashion items appropriate for the user requirements for each category such as Outer, Top, Bottom, and Shoe of FIG. 4. Let's assume that an action of creating new fashion coordination is indicated as μ_{f} an action of creating an i^{th} category-specific fashion item is indicated as μ_{f}ⁱ, an embedding vector of a question up to a time t is indicated as q_{1:t}, an embedding vector of an answer created up to the time t is indicated as a_{1:t}, the long-term memory 244 is indicated as M, fashion coordination created at the time t is indicated as fₜ, and fashion coordination created by selecting an i^{th} category-specific fashion item at the time t is indicated as fₜⁱ⁻¹. Then, the conditional probability of the action of creating new fashion coordination is expressed by Equation 1.

$$p ( {μ}_{f} \vert {f}_{t - 1} , {q}_{1 \text{:} t} , {a}_{1 \text{:} t - 1} , ℳ ) = {\prod }_{i = 1}^{N} p ( {μ}_{f}^{i} \vert {f}_{t}^{i - 1} , {q}_{1 \text{:} t} , {a}_{1 \text{:} t - 1} , ℳ ) \qquad [ Equation 1 ]$$

Here, N is the total number of categories. For the purpose of actual implementation in the present invention, Equation 1 is approximated to Equation 2.

$$p ( {μ}_{f} \vert {f}_{t - 1} , {q}_{1 \text{:} t} , {a}_{1 \text{:} t - 1} , ℳ ) \approx {\prod }_{i = 1}^{N} \frac{p ( {μ}_{f}^{i} \vert {key}_{t}^{*} , ℳ ) \cdot p ( {f}_{t}^{i} \vert {key}_{t}^{*} , ℳ )}{{Σ}_{{μ}_{f}^{t}} p ( {μ}_{f}^{i} \vert {key}_{t}^{*} , ℳ ) \cdot p ( {f}_{t}^{i} \vert {key}_{t}^{*} , ℳ )} \\ {key}_{t}^{*} = {argmax}_{{key}_{t}} p ( {key}_{t} \vert {q}_{1 \text{:} t} , {a}_{1 \text{:} t - 1} ) \qquad [ Equation 2 ]$$

The requirement estimation unit 210, the reading unit 220, and the writing unit 230 serve to calculate argmax_{key}_{ₜ}[p(keyₜ|q_{1:t},a_{1:t-1})] of Equation 2 using the working memory 250. Also, the category-specific fashion item creation unit 240 uses the long-term memory 244 when the term p(μ_{f}ⁱ|key*ₜ, [symbol] ) and the term p(fₜⁱ|key*ₜ, [symbol] ) of Equation 2 are calculated. In a configuration example of FIG. 5, the long-term memory 244 may be used for a fashion item probability calculation unit 241 and a fashion coordination evaluation unit 242 of the category-specific fashion item creation unit 240 to calculate p(μ_{f}ⁱ|key*ₜ, [symbol] ) and p(fₜⁱ|key*ₜ, [symbol] ), respectively.

The requirement estimation unit 210 creates parameters necessary to access the working memory 250 using the embedding vector of the question. Then, the requirement estimation unit 210 estimates a requirement vector using a working memory value acquired by the reading unit 220. For example, the requirement estimation unit 210 uses a neural network by forming an LSTM recurrent neural network in multiple layers and then performing linear conversion in the final layer. Working memory values that are previously read other than the embedding vector of the question are used as an input of the neural network, and parameters used to access the working memory are created as an output of the neural network. Also, a requirement vector is estimated by a deep neural network having multiple layers having the working memory values acquired by the reading unit 220 as an input.

The reading unit 220 calculates a weight for the position of the working memory 250 to be read using the parameters provided by the requirement estimation unit 210 and calculates a working memory value to be read by linearly combining the working memory values through a medium of the weight. For example, when the memory value is a deterministic value, the weight is calculated using cosine similarity. That is, when an i^{th} memory weight is w(i), an i^{th} memory value is M(i), a key for reading among the parameters is k, and a spreading degree among the parameters is β, the weight may be calculated using the cosine similarity as shown in Equation 3.

$$w ( i ) = \frac{exp ( β \frac{k \cdot ℳ ( i )}{‖ k ‖ ‖ ℳ ( i ) ‖} )}{{\sum }_{j = 1}^{M} exp ( β \frac{k \cdot ℳ ( j )}{‖ k ‖ ‖ ℳ ( j ) ‖} )} \qquad [ Equation 3 ]$$

As another example, when the memory value is a statistic value, the weight may be calculated using probability calculation. When an i^{th} memory weight is w(i), an average of an i^{th} memory value is μ(i), a variance of an i^{th} memory value is Σ(i), an average key for reading among the parameters is k_{μ}, a distribution key for reading among the parameters is k_{Σ}, and a normal distribution function is N(⋅), the weight may be calculated using probability calculation as shown in Equation 4.

$$w ( i ) = \frac{𝒩 ( {k}_{μ} , μ ( i ) , ( Σ ( i ) + {k}_{Σ} ) )}{{\sum }_{j = 1}^{M} 𝒩 ( {k}_{μ} , μ ( j ) , ( Σ ( j ) + {k}_{Σ} ) )} \qquad [ Equation 4 ]$$

The writing unit 230 performs a function of receiving the parameters from the requirement estimation unit 210 and then deleting and adding a value of the working memory 250. For example, a new working memory is obtained by calculating the weight of the position of a memory to be accessed using the cosine similarity or probability calculation and then deleting and adding the value of the working memory 250 according to the calculated weight. A method of the reading unit 220 and the writing unit 230 reading and writing the working memory 250 is a content addressing method in which a specific input value is provided and a position where the input value is stored is returned and may be used in combination with a position address method in which a relative position of the position of the working memory 250 that is currently being accessed is designated.

The category-specific fashion item creation unit 240 classifies the categories of the fashion items using wearing positions, and the category-specific fashion items are sequentially created using the long-term memory 244 and the requirement vector acquired from the requirement estimation unit 210. The category-specific fashion item creation unit 240 is used as many times as the number of categories.

The category-specific fashion item creation unit 240 may include a fashion item probability calculation unit 241, a fashion coordination evaluation unit 242, and a fashion item determination unit 243. It will be understood by those skilled in the art that these elements have no physically absolute boundaries.

The fashion item probability calculation unit 241 calculates the probability of the fashion item being appropriate for a requirement by using the above-described long-term memory 244 and the requirement vector obtained from the requirement estimation unit 210. For example, the fashion item probability calculation unit 241 calculates the probability of the fashion item being appropriate for a requirement by converting the feature vectors of the long-term memory 244 into a neural network, achieving cosine similarity between the requirement vector and the converted feature vectors, and applying a softmax function.

The fashion coordination evaluation unit 242 replaces the fashion item with a new one and evaluates whether newly configured fashion coordination is appropriate for the requirement and how well the fashion coordination fits the requirement by using the long-term memory 244, the previously created fashion coordination, and the requirement vector obtained from the requirement estimation unit 210. First, the fashion coordination evaluation unit 242 performs replacement of a fashion item in a category to which a new fashion item belongs in the previously created fashion coordination and finds fashion coordination to be evaluated. The fashion coordination to be evaluated is converted into a feature vector of the long-term memory 244, and the feature vector is combined with the requirement vector and provided as the input of the neural network. The neural network evaluates the fashion coordination.

The fashion item determination unit 243 determines a category-specific fashion item by multiplying a fashion coordination evaluation result obtained from the fashion coordination evaluation unit 242 and a fashion item probability calculated from the fashion item probability calculation unit 241 to find a maximum value.

FIG. 8 shows an example of a configuration for developing dialog and fashion coordination knowledge by training a neural network having an explicit memory used in the fashion coordination knowledge provision apparatus of FIG. 1 through reinforcement learning.

While the language embedding unit 10 is fixed, end-to-end learning is performed on a fashion coordination knowledge creation unit 20, a dialog creation unit 30, and a value estimation unit 40, using questions as training data (learning data) in a stochastic gradient descent method.

Questions of training and previously created answers of training are embedded by the language embedding unit 10.

The fashion coordination knowledge creation unit 20 creates fashion coordination knowledge through a neural network having an explicit memory by using a training embedding vector acquired by the language embedding unit 10 as an input. Also, the fashion coordination knowledge creation unit 20 transfers an internally estimated requirement vector to the value estimation unit 40. Neural networks in the fashion coordination knowledge creation unit 20 are learned by changing coefficients of the neural networks using a value obtained by multiplying a value, which is estimated by the value estimation unit 40, by a value obtained by applying a logarithm to a probability of creating fashion coordination knowledge and dialogs. A sample for creating the fashion coordination knowledge and dialogs is acquired from training answer data and training fashion coordination data. For example, when the requirement vector is keyₜ*, an action of creating a new answer is μₐ, an attenuation factor of variation is α, and the estimated value is Q, the variation Δ of the neural network coefficients are calculated as shown in Equation 5.

Δ=α·∇ log[p(μ_{f},μₐ|key*ₜ, [symbol] )]·Q(key*ₜ,μ_{f},μₐ| [symbol] ) [Equation 5]

As the input of the neural network, the dialog creation unit 30 creates an answer using the training embedding vector acquired from the language embedding unit 10 and the fashion coordination acquired by the fashion coordination knowledge creation unit 20. The learning of a neural network in the dialog creation unit 30 is performed in the same manner as that of the learning of the neural networks in the fashion coordination knowledge creation unit 20.

The value estimation unit 40 provides the requirement vector, the created fashion coordination, and the created answer data as the input of the neural network to estimate a value. Here, the value means accuracy of fashion coordination and an answer appropriate for user requirements, and the value is used as a reward to train the fashion coordination knowledge creation unit 20 and the dialog creation unit 30 through reinforcement learning. The neural network learning or training of the value estimation unit 40 is performed by changing neural network coefficients using a value obtained by applying a gradient descent to the square of the difference between the estimated value and training reward data in the opposite direction. For example, when a training reward is reward and the attenuation coefficient of variation is β, the variation Δ of the neural network coefficients may be calculated as shown in Equation 6.

Δ=β·(reward−Q(key*ₜ,μ_{f},μₐ| [symbol] ))·∇Q(key*ₜ,μ_{f},μₐ| [symbol] ) [Equation 6]

The neural network of the value estimation unit 40 and the neural networks of the fashion coordination knowledge creation unit 20 and the dialog creation unit 30 are alternatively trained.

By providing fashion coordination knowledge through a neural network having an explicit memory, it is possible to improve algorithm performance through logical flow control and memory division, effectively utilize long text information of data compared to a conventional method, and cope with sparse data better.

As described above, the present invention may be implemented in an apparatus aspect or a method aspect. In particular, a function or process of each element of the present invention may be implemented in at least one of a digital signal processor (DSP), a processor, a controller, an application-specific IC (ASIC), a programmable logic device (such as a field programmable gate array (FPGA)), and other electronic devices and as a hardware element including a combination thereof. Alternatively, the function or process may be implemented in software in combination or independently of the hardware element, and the software can be stored in a recording medium.

It should be understood by those skilled in the art that, although the present invention has been described in detail with reference to exemplary embodiments, various changes in form and details may be made therein without departing from the technical spirit and essential features of the invention as defined by the appended claims. Therefore, the above embodiments are to be regarded as illustrative rather than restrictive. The protective scope of the present invention is defined by the following claims rather than the detailed description, and all changes or modifications derived from the claims and their equivalents should be interpreted as being encompassed in the technical scope of the present invention.

What is claimed is:

1. An apparatus for providing fashion coordination knowledge based on a neural network having an explicit memory, the apparatus comprising:
a language embedding unit configured to embed a user's question and a previously created answer to acquire a digitized embedding vector;
a fashion coordination knowledge creation unit configured to create fashion coordination knowledge through the neural network having the explicit memory by using the embedding vector acquired by the language embedding unit as an input; and
a dialog creation unit configured to create dialog content for configuring the fashion coordination through the neural network having the explicit memory by using the fashion coordination knowledge acquired from the fashion coordination knowledge creation unit and the embedding vector acquired by the language embedding unit as an input.

2. The apparatus of claim 1, wherein the dialog content for configuring the fashion coordination, which is created by the dialog creation unit, includes at least one of a request for information to be added to the fashion coordination and an answer for explaining new fashion coordination.

3. The apparatus of claim 1, wherein the fashion coordination knowledge creation unit comprises:
a working memory, which is a place for memorizing previous questions and answers;
a long-term memory, which is a place for memorizing a feature of a fashion item;
a reading unit configured to calculate a value of the working memory to be read;
a writing unit configured to delete and add a value of the working memory;
a requirement estimation unit configured to create parameters necessary to access the working memory using the embedding vector acquired by the language embedding unit and configured to estimate a requirement vector using the value of the working memory acquired from the reading unit; and
a category-specific fashion item creation unit configured to classify fashion items according to predetermined categories and create a fashion item for each of the categories using the long-term memory and the requirement vector acquired from the requirement estimation unit.

4. The apparatus of claim 3, wherein the reading unit calculates a weight for a position of the working memory to be read and linearly combines the value of the working memory through a medium of the weight by using parameters acquired from the requirement estimation unit in order to calculate the value of the working memory to be read.

5. The apparatus of claim 3, wherein the writing unit calculates a weight for a position of the working memory to be written and deletes and adds the value of the working memory according to the weight by using parameters acquired from the requirement estimation unit in order to delete and add the value of the working memory.

6. The apparatus of claim 3, wherein the predetermined categories determined by the category-specific fashion item creation unit are one or more categories corresponding to fashion item wearing positions.

7. The apparatus of claim 3, wherein the category-specific fashion item creation unit comprises:
a fashion item probability calculation unit configured to calculate a fashion item probability appropriate for a requirement by using the long-term memory and the requirement vector acquired from the requirement estimation unit;
a fashion coordination evaluation unit configured to perform replacement of the fashion item and evaluate newly configured fashion coordination by using the long-term memory, previously created fashion coordination, and the requirement vector acquired from the requirement estimation unit; and
a fashion item determination unit configured to determine the fashion item from the fashion item probability acquired from the fashion item probability calculation unit and a fashion coordination evaluation result acquired from the fashion coordination evaluation unit.

8. The apparatus of claim 7, wherein the fashion item is determined by the fashion item determination unit multiplying the fashion item probability and the fashion coordination evaluation result and then finding a maximum value.

9. The apparatus of claim 3, further comprising a value estimation unit configured to estimate a value using the neural network having the explicit memory by using the requirement vector acquired from the requirement estimation unit, the fashion coordination acquired from the fashion coordination knowledge creation unit, and answer data acquired from the dialog creation unit.

10. The apparatus of claim 9, wherein the neural network of the fashion coordination knowledge creation unit receives and learns the value estimated by the value estimation unit and the fashion coordination knowledge.

11. The apparatus of claim 9, wherein the neural network of the value estimation unit performs learning using a difference between the estimated value and training reward data.

12. The apparatus of claim 9, wherein the neural network of the dialog creation unit performs learning using the fashion coordination and a dialog creation probability acquired from the dialog creation unit.

13. A method of providing fashion coordination knowledge based on a neural network having an explicit memory, the method comprising:
embedding a user's question and a previously created answer to acquire a digitized embedding vector;
creating fashion coordination knowledge through the neural network having the explicit memory by using the embedding vector as an input; and
creating dialog content for configuring fashion coordination through the neural network having the explicit memory by using the embedding vector and the created fashion coordination knowledge as an input.

14. The method of claim 13, wherein the creating of the fashion coordination knowledge comprises:
creating parameters necessary to access a working memory, which is a place for memorizing previous questions and answers, using the embedding vector and estimating a requirement vector; and
classifying fashion items according to predetermined categories and creating a fashion item for each of the categories using the requirement vector acquired from a requirement estimation unit and a long-term memory, which is a place for memorizing a feature of the fashion item.

15. The method of claim 14, wherein the creating of the fashion item for each of the categories comprises:
calculating a probability of a fashion item appropriate for a requirement by using the long-term memory and the requirement vector;
performing replacement of the fashion item and evaluating newly configured fashion coordination by using the long-term memory, previously created fashion coordination, and the requirement vector; and
determining the fashion item from the fashion item probability and a fashion coordination evaluation result.

16. The method of claim 13, further comprising estimating a value using the neural network having the explicit memory by using a requirement vector, the fashion coordination, and the created dialog content.
